(19) United States
(12) Patent Application Publication
(10) Pub. No.: US 2002/0152033 A1
(43) Pub. Date: Oct. 17, 2002

(54) Method for evaluating the quality of database search results by means of expectation value

(76) Inventors: Ronald C. Beavis, Winnipeg (CA); David Fenyo, New York, NY (US)

Correspondence Address: HOFFMANN & BARON, LLP, 6900 JERICHO TURNPIKE, SYOSSET, NY, 11791, US

(21) Appl. No.: 09/792,614

(22) Filed: Feb. 23, 2001

(51) Int. Cl. G06F 19/00

(52) U.S. Cl. 702/19

(57) ABSTRACT

A method for determining the probability that a biological molecule identification is random for a chosen significance level and for a particular experimental condition, the method comprising:

(a) providing biological molecule identification search result scores for an unknown biological molecule;

(b) determining the frequency of each score to provide a frequency distribution of the scores;

(c) determining the score associated with the mean of the distribution;

(d) selecting parameters, defined as p₁ and p₂, wherein p₁ is a score within a 10% range of the score associated with the mean, and p₂ is a score which is greater than p₁ and which has a frequency 1-15% of the frequency of p₁;

(e) fitting the distribution into a curve between points p₁ and p₂;

(f) choosing a test score;

(g) extrapolating the curve to obtain an expected frequency of the test score; and

(h) assessing the expected frequency of the test score to determine the probability that the biological molecule identification is random for the chosen significance level.

### BACKGROUND

An unknown biological molecule can be identified by comparing the mass data of the unknown biological molecule with mass data of known biological molecules.

For example, the rapid growth of available high quality DNA sequence data has made mass spectrometry (MS) combined with genome database searching a popular and potentially accurate method to identify proteins. Protein identification by mass spectrometry has proven to be a powerful tool to elucidate biological function and to find the composition of protein complexes and entire organelles.

In protein identification experiments, proteins are typically separated by gel electrophoresis, subjected to a protease having high digestion specificity (e.g. trypsin) and the resulting mixture of peptides is extracted from the gel and subjected to MS-analysis. The distribution of proteolytic peptide masses (peptide map) is compared with theoretical proteolytical peptide masses calculated for each protein stored in a protein/DNA sequence database.

There are various algorithms that attempt to identify unknown proteins. These algorithms use the experimentally obtained data of unknown proteins and compare it with the data of known proteins in a database. A simple algorithm for the measure of similarity calculates the number of experimental masses that are similar to at least one theoretical mass. For example, the masses of an experimental peptide map of an enzymatically digested unknown protein can be compared with the theoretical masses calculated by applying the rules for the specificity of the enzyme to the amino acid sequence of a database protein. These algorithms yield search results which include the protein identified and an identification score on the basis of the similarity of the data of the unknown protein and the data base proteins.

Examples of commercially available protein identification algorithms include Bayesian ProFound, “MOWSE (modified)” (MS-Fit), “MOWSE (probability based)” (Mascot) and “Number of Matches” (MS-Fit). Sophisticated algorithms can be used to generate a score. For example, ProFound (ProteoMetrics) is a software tool for searching protein sequence databases. ProFound's score is “the probability that a specific protein is the protein being analyzed” using a Bayesian statistical framework.

However, due to imperfections in protein separation and to incomplete extraction of the proteolytic peptides from gels, peptide maps are typically incomplete, and also contain a background of proteolytic peptide masses from one or several other proteins. Even if separation and extraction were perfect, posttranslational modifications of proteins would cause a proteolytic peptide mass distribution different from that predicted by the genome. Mass spectrometry determines a peptide mass mi to an accuracy ±Δmₗ, with Δmₗ/mₗ typically >30 ppm. Within the mass range mₗ±Δmₗ proteolytic peptide masses of several proteins in the genome can match. For these reasons, a database search using the information in a peptide map will not always identify a protein unambiguously.

Methods for evaluating the quality of a protein identification result have recently been provided. However, such methods may be computationally intensive, may not always be readily integrated with search programs, may need to set different standards for different databases, and/or may be difficult for a user to interpret. As increasingly complex biological problems are explored, simplified methods to evaluate the quality of a protein identification result are critical.

The object of the present invention is to provide a method for evaluating the quality of a biological molecule identification which is substantially less computationally intensive and easier for a user to interpret than prior methods. In one embodiment, present invention provides an evaluation of the quality of a protein identification score in a fraction of a second. Additionally, the present invention provides a standard criterion by which to evaluate the quality of a particular protein identification result regardless of the size of the database.

### SUMMARY OF THE INVENTION

These and other objects, as will be apparent to those having ordinary skill in the art, have been met by providing a for determining the probability that a biological molecule identification is random for a chosen significance level and for a particular experimental condition, the method comprising: (a) providing biological molecule identification search result scores for an unknown biological molecule; (b) determining the frequency of each score to provide a frequency distribution of the scores; (c) determining the score associated with the mean of the distribution; (d) selecting parameters, defined as p₁ and p₂, wherein p₁ is a score within a 10% range of the score associated with the mean, and p₂ is a score which is greater than p₁ and which has a frequency 1-15% of the frequency of p₁; (e) fitting the distribution into a curve between points p₁ and p₂; (f) choosing a test score; (g) extrapolating the curve to obtain an expected frequency of the test score; and (h) assessing the expected frequency of the test score to determine the probability that the biological molecule identification is random for the chosen significance level. No particular order is required for the performance of these steps.

The invention further provides a computer usable medium for determining a probability that a biological molecule identification is random for a chosen significance level and for a particular experimental condition, the computer usable medium comprising: a) a means for providing biological molecule identification search result scores for an unknown biological molecule; (b) a means for determining the frequency of each score to provide a frequency distribution of the scores; (c) a means for determining the score associated with the mean of the distribution; (d) a means for selecting parameters, defined by p₁ and p₂; wherein p₁ is a score within a 10% range of the score associated with the mean, and p₂ is a score which is greater than p₁ and which has a frequency 1%-15% of the frequency of p₁; (e) a means for fitting the distribution into a curve; (f) a means for choosing a test score; (g) a means for extrapolating the curve to obtain an expected frequency of the test score; and (h) a means for assessing the expected frequency of the test score to determine the probability that the biological molecule identification is random for the chosen significance level. No particular order is required for the performance of these steps.

The invention further provides a computer program product comprising: a computer usable medium having computer readable program code means embodied in said medium for determining a probability that a biological identification is random for a chosen significance level and for a particular experimental condition, said computer program product including: computer readable program code means for causing a computer to generate biological molecules identification search result scores for an unknown biological molecule; computer readable program code means for causing the computer to determine the frequency of each score to provide a frequency distribution of scores; computer readable program code means for causing the computer to determine the score associated with the mean of the distribution; computer readable program code means for causing the computer to select parameters, defined as p₁ and p₂; wherein p₁ is a score within a 10% range of the score associated with the mean, and p₂ is a score which is greater than p₁ and which has a frequency 1%-15% of the frequency of p₁; computer readable program code means for causing the computer to fit the distribution into a curve between points p₁ and p_{2;} computer readable program code means for causing the computer to choose a test score; computer readable program code means for causing the computer to extrapolate the curve to obtain an expected frequency of the test score; and computer readable program code means for causing the computer to assess the expected frequency of the test score to determine the probability that the biological molecule identification is random for the chosen significance level. No particular order is required for the performance of these steps.

### DESCRIPTION OF FIGURES

FIG. 1: The distribution of the logarithm of unnormalized probability scores obtained when mass data derived from transketolase A. is searched against S. cerevisiea.

FIG. 2: The distribution of the logarithm of unnormalized probability scores obtained when mass data derived from transketolase A. is searched against Viridiplantae.

FIG. 3: The high p value tail of FIG. 1.

FIG. 4: A plot of the high probability tail of the distribution in FIG. 1, using log (# results) as the y-axis.

FIG. 5: A plot of the high probability tail of the distribution in FIG. 2, using log (# results) as the y-axis.

FIG. 6: Diagram demonstrating protein identification using mass spectrometry. The spectrum generated by an experimental protein is compared with mass spectrum generated by theoretical proteins.

### DETAILED DESCRIPTION

In one embodiment the invention provides a method for determining the probability that a biological molecule identification is random for a chosen significance level. For the purposes of this invention, the identification is the result obtained for an unknown biological molecule after a search of known biological molecules. So, for example, a protein identification is the result obtained for an unknown protein after a search of known proteins; that is, the protein identification is a known protein which is identified as being the unknown protein.

Biological molecules include any biological polymer that can be degraded into constituent parts. The degradation is preferably into constituent parts at predictable positions to form predictable masses. Examples of biological molecules include proteins, nucleic acid molecules, polysaccharides and carbohydrates.

Proteins are polymers of amino acids. Constituent parts of proteins comprise amino acids. A protein typically contains approximately at least ten amino acids, preferably at least fifty amino acids and more preferably at least 100 amino acids.

Nucleic acids are polymers of nucleotides. Constituent parts of nucleic acids comprise nucleotides. Typically, a nucleic acid contains at least 100 nucleotides, preferably at least 500 nucleotides.

Polysaccharides are polymers of monosaccharides. Constituent parts of polysaccharides comprise one or more monosaccharides. Typically, a polysaccharide contains at least five monosaccharides, preferably at least ten monosaccharides.

Mass data of biological molecules are quantifiable information about the masses of the constituent parts of the biological molecule. Mass data include individual mass spectra and groups of mass spectra. The mass spectra can be in the form of peptide maps, oglionucleotide maps or oligosaccharide maps. For the purposes of this invention, mass data include mass data of the full-length biological molecule or fragments thereof.

For example, mass data for proteins can be generated in any manner which provides mass data within a certain accuracy. Examples include matrix-assisted laser desorption/ionization mass spectrometry, electrospray ionization mass spectrometry, chromatography and electrophoresis. Mass data can also be generated by a general purpose computer configured by software or otherwise.

For the purposes of the present invention the mass data, for example a peptide mass, mₗ, is determined to an accuracy ±Δmₗ, with Δmₗ/mₗ preferably <10,000 ppm, more preferably <100 ppm and most preferably <30 ppm.

A step in generating mass data of a biological molecule can include first cleaving the biological molecule into constituent parts. Biological molecules can be cleaved by methods known in the art. Preferably, the biological molecules are cleaved into constituent parts at predictable positions to form predictable masses. Methods of cleaving include chemical degradation of the biological molecules. Biological molecules can be degraded by contacting the biological molecule with any chemical substance.

For example, proteins may be predictably degraded into peptides by means of cyanogen bromide and enzymes, such as trypsin, endoproteinase Asp-N, V8 protease, endoproteinase Arg-C, etc. Nucleic acids may be predictably degraded into constituent parts by means of restriction endonucleases, such as Eco RI, Sma I, BamH I, Hinc II, etc. Polysaccharides may be degraded into constituent parts by means of enzymes, such as maltase, amylase, alpha-mannosidase, etc.

The invention relates to improving current methods for identifying biological molecules by adding to current methods a non-computationally intensive method of evaluating the quality of the identification. Current methods for identifying biological molecules as well as the methods of the present invention will be described for protein identification. These methods are equally applicable to any biological molecule.

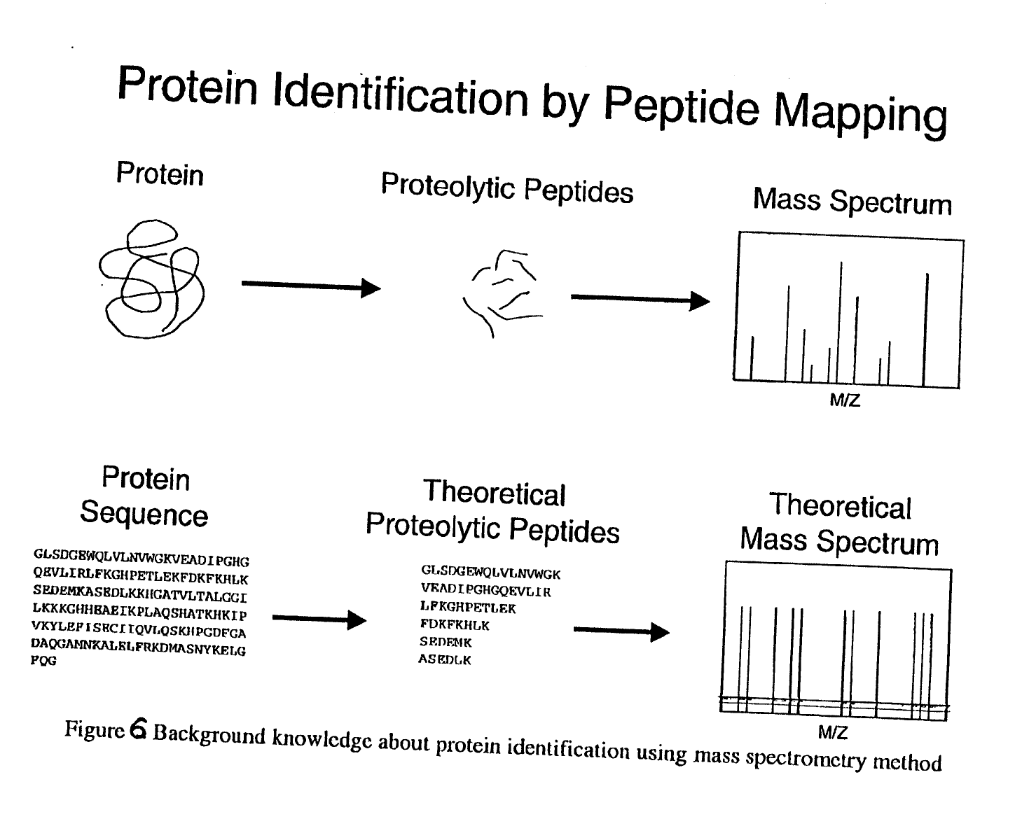

Current methods used to identify unknown proteins are typically similar to that illustrated in FIG. 6, but with the addition of database searching. The unknown protein is first cleaved into its constituent parts, as described above. The masses of the resulting constituent parts are analyzed and experimental mass data are generated. The determined masses are then compared with theoretical mass data generated for polypeptide sequences of a DNA (genome, cDNA, or otherwise) and/or protein database. Typically, the masses in a database are from a single organism. Additionally, an unknown protein to be identified can be in a mixture of proteins.

A biological molecule database is any compilation of information about characteristics of biological molecules. Databases are the preferred method for storing both polypeptide amino acid sequences and the nucleic acid sequences that code for these polypeptides. The databases come in a variety of different types that have advantages and disadvantages when viewed as the hypothesis for a polypeptide identification experiment.

While the “database entry” for an amino acid sequence may appear to be a simple text file to a user browsing for a particular polypeptide, many databases are organized into very flexible, complicated structures. The detailed implementation of the database on a particular system may be based on a collection of simple text files (a “flat-file” database), a collection of tables (a “relational” database), or it may be organized around concepts that stem from the idea of a protein, gene, or organism (an “object-oriented” database).

Protein mass data may be predicted from nucleic acid sequence databases. Alternatively, protein mass data may be obtained directly from protein sequence databases which contain a collection of amino acid sequences represented by a string of single-letter or three-letter codes for the residues in a polypeptide, starting at the N-terminus of the sequence. These codes may contain nonstandard characters to indicate ambiguity at a particular site (such as “B” indicating that the residue may be “D” (aspartic acid) or “N” (asparagine). The sequences typically have a unique number-letter combination associated with them that is used internally by the database to identify the sequence, usually referred to as the accession number for the sequence.

Databases may contain a combination of amino acid sequences, comments, literature references, and notes on known post translational modifications to the sequence. A database that contains these elements is referred to as “annotated.” Annotated databases are used if some functional or structural information is known about the mature protein, as opposed to a sequence that is known only from the translation of a stretch of nucleic acid sequence. Non-annotated databases only contain the sequence, an accession number, and a descriptive title.

In general, each comparison of the unknown protein with the database proteins is assigned a score on the basis of a reasonable algorithm. Algorithms, discussed below, exist that measure the probability that a particular sequence could give rise to the experimental results. The comparisons can be made and scores can be generated by a general purpose computer configured by software or otherwise. The unknown protein is then “identified” with a sequence that produces a score having a high degree of similarity.

More specifically, a score is a measure of the degree of similarity between the theoretical mass data of a database protein and the experimental mass data of an unknown protein for the same experimental conditions. The experimental mass data is the mass data that was generated and measured for the unknown protein under particular experimental conditions.

Experimental conditions are any conditions under which mass data is generated. An example of an experimental condition is the manner in which cleavage of the biological molecules is accomplished, that is, the specific substance used for the chemical degradation of the biological molecules. Additionally, the experimental condition defines the efficiency of the chemical degradation. The efficiency of a chemical degradation specifies the number of potential cleavage sites that may be expected to remain uncleaved.

Scores which denote a high degree of similarity are usually the top twenty scores generated in a comparison, more preferably the top ten scores, even more preferably the top five scores and most preferably the top one score.

A similarity between a group of experimental masses of the unknown protein and a group of theoretical masses of a database protein is assessed by comparing every experimental mass with every theoretical mass. A simple algorithm for the measure of similarity is the number of experimental masses that are similar to at least one theoretical mass. For example, the masses of an experimental peptide map of an enzymatically digested unknown protein can be compared with the theoretical masses calculated by applying the rules for the specificity of the enzyme to the amino acid sequence of a database protein.

More sophisticated algorithms can be used to generate a score. For example, ProFound (ProteoMetrics) is a software tool for searching protein sequence databases. ProFound measures similarity using a Bayesian statistical framework.

In the present invention an experimental mass data of an unknown protein and one of the mass data of the proteins of the database are said to be similar if the absolute value of the difference between them is less than the uncertainty in the measurement.

The similarity between the mass data of the unknown protein and each of the theoretical mass data of the database proteins is assessed taking into account the accuracy of the determination of the mass data by a particular method. For example, mass spectrometry determines a peptide mass mₗ to an accuracy of ±Δm₁, with Δmₗ/mₗ typically >30 ppm. Therefore, within the mass range mₗ±Δmₗ peptide masses of several proteins in the database are considered to match the unknown protein.

The observed molecular mass or the observed isoelectric point of a protein can be used in combination with the measured masses of peptides generated by proteolysis to constrain the search for a polypeptide. In particular, the comparison between the theoretical mass data of the database proteins and the mass data of the unknown protein may be constrained to only those proteins of the database which are within a chosen mass range. The chosen mass range is preferably within 50% of the mass of the unknown protein, more preferably within 35%, most preferably within 25%.

Similarly, the comparison between the theoretical mass data of the database proteins and the mass data of the unknown protein may be constrained to only those proteins of the database which are within a chosen isoelectric point range. The isoelectric point (pI) of a protein is the pH at which its net charge is zero. The chosen isoelectric point range is preferably within 50% of the isoelectric point of the unknown protein, more preferably within 35%, most preferably within 25%.

Using the observed molecular mass or isoelectric point of a polypeptide to constrain a search must be done carefully. When nonannotated nucleotide sequence databases are used (such as TREMBL or GENPEPT), subsequent processing can greatly alter the pI or molecular mass of a protein, so much so that no identification can be made. For example, the small, highly conserved protein ubiquitin (SWISSPROT accession number P02248) has a molecular mass of 8.6 kD, which is the mass that would be measured by a mass spectrometer or a gel. A simple keyword search of the translated-nucleotide database GENPEPT results in several sequences for the same protein [accession numbers M26880 (77 kD), U49869 (25.8 kD) and X63237 (17.9 kD)]. None of these nucleotide-translated sequences give the correct molecular mass or pI, so using those parameters to limit a search would result in missing the database sequence altogether. Only annotated databases that fully outline known modifications can be used when the properties of the mature protein are being used to constrain a search.

Biological molecules may undergo common modifications in their structure. The mass data that are generated from a biological molecule database may include mass data representing biological molecules with common modifications.

Examples of such modifications are post translational modifications of proteins. The modification state of a protein is usually not known in detail. In database searches, it can be useful to assume that some common modifications might be present. This is achieved by comparing the measured peptides masses of the unknown protein with both the masses of the unmodified and modified peptides in the database.

Examples of post translational modifications include glycosylation and the oxidation of the amino acid methionine. Another example is the phosphorylation of the amino acids serine, threonine, and tyrosine. Phosphorylation is often used to activate or deactivate proteins and the phosphorylation state of an experimentally observed protein depends on may factors including the phase of the cell cycle and environmental factors.

Optionally, further information of the unknown protein's sequence is obtained by generating fragment mass data. Fragment mass data for a peptide can be generated in any manner which provides fragment mass data within a certain accuracy. Experimental conditions include the type of energy used to generate the fragment mass data. Vibrational excitation energy can be used. The vibrational excitation may be generated by collisions of the peptide with electrons, photons, gas molecules or a surface. Electronic excitation can be used. The electronic excitation may be generated by collisions of the peptide with electrons, photons, gas molecules (e.g. argon) or a surface.

In another example, the experimental fragment mass spectrum of a peptide from an enzymatically digested unknown protein is compared with the theoretical masses calculated by applying the rules for the specificity of the enzyme, and the rules for the fragmentation as known to those of ordinary skill in the art, to the amino acid sequence of a database protein. For example, the software tool PepFrag (ProteoMetrics) allows for searching protein or nucleotide sequence databases using a combination of mass spectra data and fragmentation mass spectra data.

Fragment mass data for the purposes of this invention can be generated by using multidimensional mass spectrometry (MS/MS), also known as tandem mass spectrometry. A number of types of mass spectrometers can be used including a triple-quadruple mass spectrometer, a Fourier-transform cyclotron resonance mass spectrometer, a tandem time-of-flight mass spectrometer, and a quadruple ion trap mass spectrometer. A single peptide from a protein digest is subjected to MS/MS measurement and the observed pattern of fragment ions is compared to the patterns of fragment ions predicted from database sequences.

All of the protein identification strategies outlined above to generate a score are currently available as CGI programs that can be accessed using a browser.

There is a risk of false identification of the unknown protein for several reasons. For example, each proteolytic peptide mass measured can be found in several proteins in a genome database. Also for example, a peptide map is often incomplete with respect to the protein identified and can contain a background of proteolytic peptide masses from other proteins. An identification of a protein is definitely uncertain if the result is characterized by a score that could as well be due to random matching between the peptide map and a protein in the database.

This invention provides a method of determining the probability that a biological molecule identification is random for a chosen significance level based on a comparison between theoretical mass data and experimental mass data.

The method comprises generating theoretical mass data for a particular experimental condition for known proteins from a protein sequence database as described above. Experimental mass data for an unknown protein for the same experimental condition is also generated.

The experimental mass data, and optionally fragment mass data, generated for the unknown protein is compared with the theoretical data generated for each known protein in the database. The comparisons are carried out as described above. An identification result score is calculated for each comparison. The score is a function of the similarity between each of the theoretical mass data as compared with the experimental mass data of the unknown protein. Each protein in the database can be referred to as a candidate to which a score is assigned.

The hypothesis used in the present invention is that all the scores are generated by random identifications (i.e., incorrect identifications). However, for each protein identification there is a different probability that this hypothesis is true. So at a certain probability it can be considered reasonable to reject the hypothesis. This probability is termed a significance level. In other words, a significance level is the probability used as the criterion for rejecting the hypothesis.

The method comprises the generation of a frequency distribution of the scores which can, optionally, be plotted. For example, the scores can be plotted on the horizontal axis; and the frequency of the occurrence of a particular score can be plotted on the vertical axis. Typically distributions are plotted so that the scores increase in value from left to right. Therefore, in general, candidates which generated the scores in the right end of the distribution are more similar to the unknown protein than the rest of the candidates. These distributions are typically positively skewed and have a right “tail.” It follows that this “tail” contains candidates that have the greatest possibility to contain the correct protein identification.

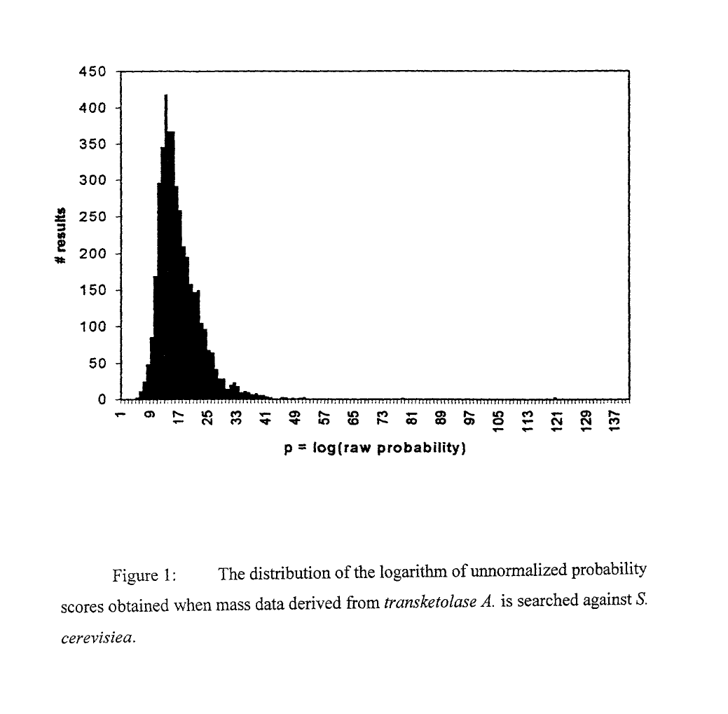

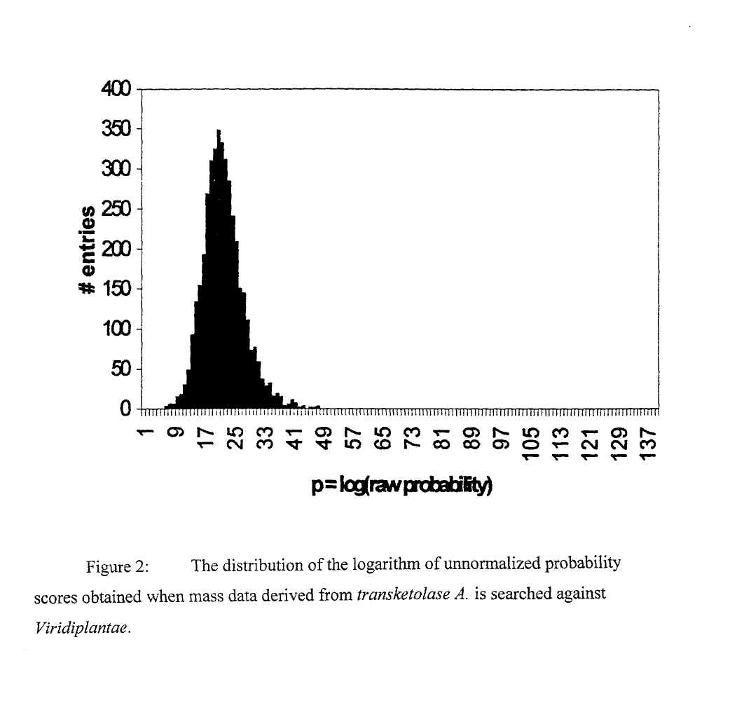

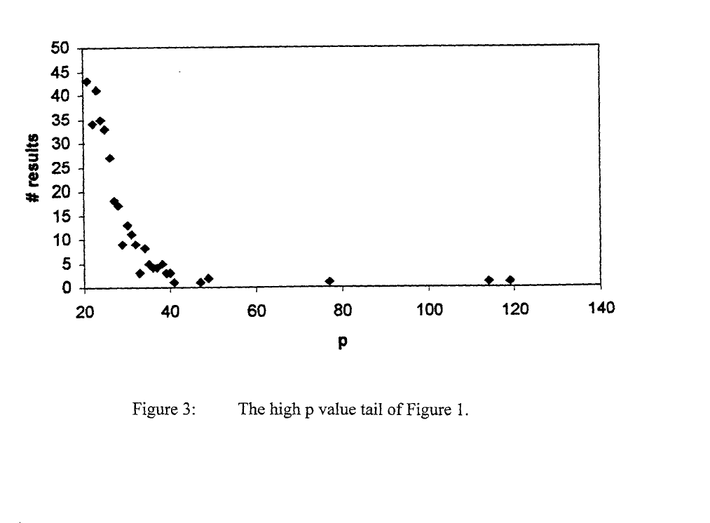

For example, FIGS. 1 and 2 are frequency distributions of scores that resulted from sample database searches using the algorithm employed by Profound. The horizontal axis represents the logarithm of unnormalized (raw) Profound scores, designated as p. FIG. 3 shows the high p value tail of FIG. 1, constructed from the 512 best scoring results. The three highest scoring values are all true matches.

The score frequency distributions can be analyzed in terms of expectation value. The expectation value of a parameter is the value that the parameter is predicted to be, based on the general tendency demonstrated by a statistical distribution. In particular, the frequency of the scores can be analyzed using an expectation value designated as an Expected Number of Results function (ENR). More specifically, ENR(pᵣₑₛᵤₗₜ) assigns a value to a protein identification result, wherein the value is the number of proteins that were found to match an experimental protein at the particular score, pᵣₑₛᵤₗₜ. For example, an ENR(pᵣₑₛᵤₗₜ) of 100 indicates that 100 protein identifications obtained the score p.

The preponderance of values in these frequency distributions tend to be at low score values. Such low score values are generally associated with random matching. As the score increases, the ENR dramatically decreases. If a very low frequency, high score result is found, it is generally associated with a nonrandom identification. Accordingly, a simple interpretation of a protein identification result (pᵣₑₛᵤₗₜ) using the ENR(p) follows:

1. if ENR(pᵣₑₛᵤₗₜ) <<1, the result corresponds to a nonrandom match; and

2. if ENR (pᵣₑₛᵤₗₜ) ˜1 (or >1), the result corresponds to a value that would be reasonably expected from random matching. In other words, the smaller the value of ENR (pᵣₑₛᵤₗₜ), the more likely that the result if a true match.

For example, the preponderance of values in the frequency distributions shown in FIGS. 1 and 2, tend to be at low p values, i.e., from p˜10-25 in FIG. 1 and from p˜15-30 in FIG. 2. These low p values indicate random matching. The ENR(p) at the maximum of the distribution in FIG. 2 is ˜350. Going to the right of the maximum, the ENR decreases as p increases. The ENR(p) for p=45 is ˜1. The ENR(p) for p>60 is ˜0.

In order to analyze the expectation values of a frequency distribution, the distribution, or portion of the distribution, is analyzed by curve fitting. Curve fitting is a process of finding the best fit of data points into a selected curve by minimizing the difference between the curve and the data points. A curve is any graph that can be mathematically interpreted. For the purposes of this invention a curve includes a line. Other examples of curves include, for example, an exponential curve, a sigmoidal curve, a parabolic curve, and a hyperbolic curve. A distribution is amenable to curve fitting if the distribution can be roughly described in terms of a curve, i.e., the distribution implies a curve. The curve fitting is performed between two endpoints, designated as p₁ and p₂

A frequency distribution may need to be transformed in order to be amenable to curve fitting. A transformation of data values is done by applying the same function to each data value. The distribution can be transformed to be amenable to fit any curve that can be mathematically interpreted. Most preferably the distribution is transformed into a curve which implies a straight line dependence of the frequency values on the score values. However, other transformations can be used which transform the distribution into other types of curves.

The frequency distributions, or portions of the frequency distributions, described above are preferably logarithmically transformed to generate straight lines. Thus, an assumption is made that the underlying functional form of the ENR function, or at least part of the ENR function, is a logarithmic function. Accordingly, the logarithm is taken of each score value and each frequency value. Logarithms in base 10 or base e are preferably used, but any base can be used. Additionally, instead of the transformation, frequency'=log(frequency), the transformation, frequency'=log(frequency+1), can be used.

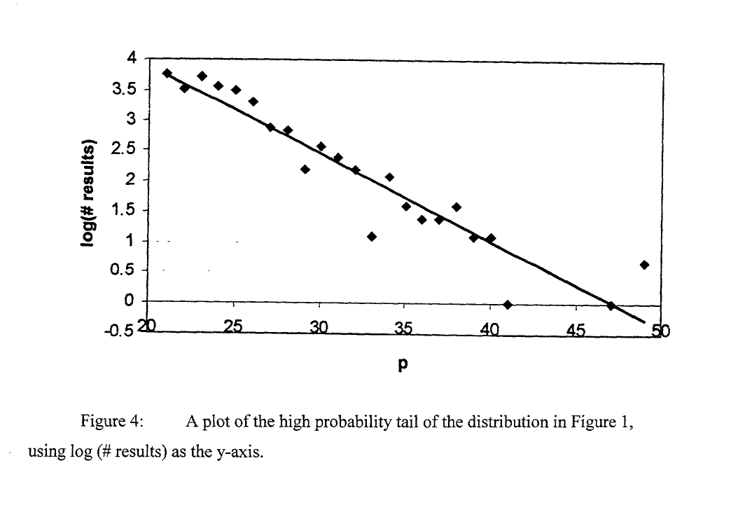

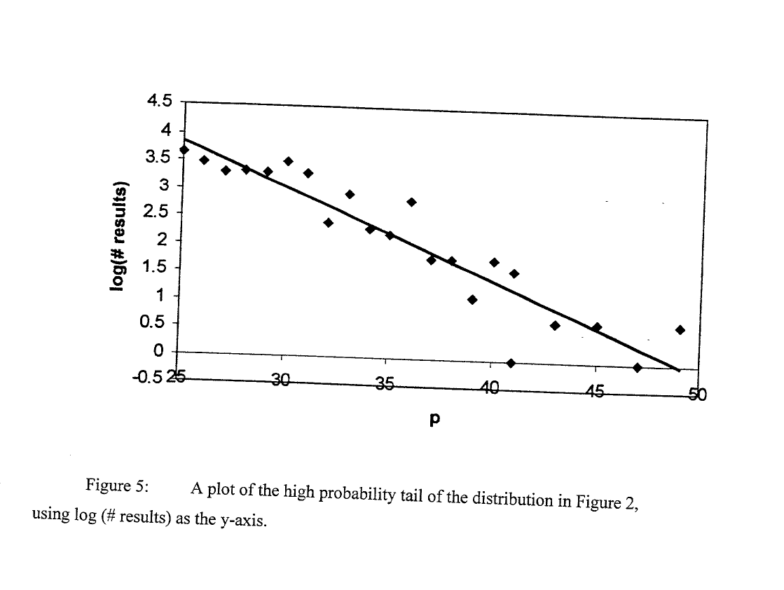

For example, the data of FIG. 1 was transformed, as described above. FIG. 4 is a plot of the tail (20<p<50) of this transformed data. FIG. 4 shows that there is a logarithmic tail on the distribution. Similarly, the data of FIG. 2 was transformed. FIG. 5 is a plot of the tail (25<p<50) of this transformed data, showing the same functional form.

In the preferred embodiment, where the data points are logarithmically transformed to imply a straight line, curve fitting is preferably performed by a linear regression. In particular, a linear regression is taken of a portion of the transformed frequency distribution defined by two endpoints. A linear regression is a statistical procedure for fitting the best straight line through a set of data points. The line can be described as y=mx+b, where m is the slope of the line and b is the y-intercept. The quality of the fit of the line to the data is described by R², the coefficient of determination, which represents the proportion of the variation in y that is predicted by the equation relating y to x. In other words, R² is the measure of the strength of the straight-line relationship. This coefficient can vary between 0 and 1. A value of 0 indicates the worst possible fit with the x variable not predicting the y variable at all. The value of 1 indicates that the value of the y variable is predicted perfectly by knowing the value of the x variable. R²=[((Σxy)²/Σx²)/Σy²].

For example, a linear regression performed on the data points of FIG. 4 generate the line defined by the equation: log (# results)=−0.1426p+6.7402 and R²=0.884. A linear regression performed on the data points of FIG. 5 generate the line defined by the equation: log (# results)=−0.624p+7.912 and R²=0.884.

The curve generated by the curve fitting analysis is then extrapolated beyond the selected endpoints. An extrapolation is a projection or extension of a curve. Such an extrapolation provides an estimate of the ENR function beyond the selected endpoints for the frequency distribution of a particular identification run. That is, the extrapolation defines what the expected frequency would be for a particular score.

A test score is preferably chosen from the high scores in the right tail of the distribution. The test score is preferably greater than the far right endpoint. The extrapolated curve defines the frequency value which would be expected at the test score. This expected frequency is evaluated in order to determine the probability that the test score, observed for a particular protein identification result, was obtained at random for a particular significance level. In general, if this expected frequency value indicates that a particular Presult, associated with a high score, occurs rarely, then the result may be considered to have been obtained by a nonrandom match for a particular significance level.

The exact location of the curve is determined by the endpoints through which the curve fitting is performed. That is, for example, the endpoints selected for a line affect the slope of a line and where the line crosses the x-axis. Thus, it follows that the stringency of the probabilistic determination is affected by which endpoints are selected. The endpoints are referred to as p₁ and p₂.

In a preferred embodiment, the endpoints are selected from the frequency distribution before transformation of the of the frequency values. The p₁ value is preferably the score within a 10% range of the score associated with the mean; more preferable p₁ is within a 5% range of the mean; and most preferably p₁ is the mean. The p₂ value is a score which is greater than p₁ and preferably has a frequency 1-25% of the frequency of p₁; more preferably 5-15% of the frequency of p₁; and most preferably 10% of the frequency of p₁. In general, the smaller the fraction p₂ is of p₁, the more stringent the probabilistic determination is.

In another embodiment, the planed pican be selected after the transformation. In particular, numerous pairs of potential endpoints can be tested to find the endpoints which would be most amenable to fit a particular type of curve. In general, the endpoints which are found to be best suited to fit the curve are chosen. For example, for a line, R² values are calculated for numerous pairs of points. The pair of points which generate the greatest R² value would preferably be chosen. The second or third greatest R² value can also be chosen. The limits on the range for p₁ and p₁, as described above, would still apply.

As described above, the hypothesis used in the present invention is that all the protein identification results were obtained by random matching. This is the null hypothesis. However, for each identification, there is a different probability that this hypothesis is true. This probability is based on the expected frequency calculations, described above. If the probability reaches a certain low level, then the null hypothesis may be rejected and the alternate hypothesis may be accepted. The alternate hypothesis is that the protein identification was not obtained at random.

The significance level may be any value in the range from about from 1×10⁻¹⁰ to about 0.1, more preferably in the range from about 0.001 to about 0.01. So, for example, if 0.01 is chosen as the significance level then there is only a 1% probability of being incorrect when considering a protein identification to be a nonrandom match.

Take for example a frequency distribution which is transformed logarithmically with the base of 10. A linear regression and extrapolation as described above is performed. If the extrapolated line defines an expected log(frequency) for a particular test score to have a value of −2, this indicates that the expected frequency of the particular test score is 0.01. Thus, if a protein identification result is observed at the test score and a significance level of, for example 0.001, is chosen, then the identification will be considered to be obtained by random matching. As another example, if the extrapolated line defines an expected log(frequency) for a particular test score to have a value of −3, this indicates that the expected frequency of the particular test score is 0.001. Thus, if at least one protein identification is observed at the test score and a significance level of, for example 0.05, is chosen, then the match will be considered to be obtained by a nonrandom match.

When considering what significance level should be chosen a number of parameters can be assessed, such as the number of masses in the peptide map, the mass accuracy, the degree of incomplete enzymatic cleavage, the protein mass range, and the size of the genome.

A general feature of significance testing is that as the significance level is decreased, the relative frequency of random, incorrect matches considered to be nonrandom matches ( i.e., a correct identification) is expected to decrease, and the relative frequency of nonrandom matches considered to be random matches is expected to increase.

Significance testing has the potential to be used as a quick check for determining whether an identification is likely to be a random match. However, significance testing can never tell if a result is correct or incorrect. Only biological methods have the potential of showing if a protein identification result is true.

In one embodiment of the present invention a protein identification can be conducted where in which the mass data of the unknown protein is compared with groups of selected amino acids (instead of compared with known proteins in a database). A group of amino acids is a set of amino acids. The molecular weight of the unknown protein is calculated. Groups of amino acids are selected to form proteins which have a similar molecular weight to the unknown protein. A molecular weight is considered to be similar if it is substantially identical to the molecular weight of the unknown protein within a preselected range. Mass data are generated for these proteins and the unknown protein. Comparisons of the mass data and expectation value evaluations are conducted as described above.

It is to be appreciated that the methods or algorithms of the present invention described herein above may be performed using a general purpose computer or processing system which is capable of running application software programs, such as an IBM personal computer (PC) or suitable equivalent thereof. Preferably, the application program code is embedded in a computer readable medium, such as a floppy disk or computer compact disk (CD). Furthermore, the computer readable medium may be in the form of a hard disk or memory (e.g., random access memory or read only memory) included in the general purpose computer.

As appreciated by one skilled in the art, the computer software code may be written, using any suitable programming language, for example, C or Pascal, to configure the computer to perform the methods of the present invention. While it is preferred that a computer program be used to accomplish any of the methods of the present invention, it is similarly contemplated that the computer may be utilized to perform only a certain specific step or task in an overall method, as determined by the user.

Preferably, the methods of the present invention are used with one or more displays (e.g., conventional CRT or liquid crystal display) provided with the processing system for presenting an indication of, for example, the final result of the process or algorithm. The display may preferably be utilized to present such information graphically (e.g., charts or three dimensional models of biological molecules) for further clarity.

In addition to performing the necessary calculations and processing functions in accordance with the present invention, the general purpose computer may also be used, for example, to store data pertaining to known biological molecules corresponding to a predetermined experimental condition. Such information may be stored on a hard disk or other memory, either volatile or non-volatile, included in the computer. Similarly, the information may be stored on a computer readable medium, such as floppy disk or CD, which can be transported for use on another computer system, as appreciated by those skilled in the art. In this manner, the methods of the present invention may be performed on any suitable general purpose computer and are not limited to a dedicated system.

Those of ordinary skill in the art will recognize that the present invention has wide applicability for identification of unknown biological molecules. Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the present invention.

### EXAMPLES

FIG. 1 shows the distribution of the logarithm of unnormalized probability scores obtained when mass data derived from transketolase A. is searched against S. cerevisiea (yeast). FIG. 3 shows the high p value tail of FIG. 1, constructed from the 512 best scoring results. The three high scoring values are all accurate (nonrandom) identifications. The highest scoring result has a log raw probability score of 119. The distribution was derived from the top 4096 results (mean=15.6, sd=6.2).

FIG. 2 shows the distribution of the logarithm of unnormalized probability scores obtained when mass data derived from transketolase A. is searched against Viridiplantae (green plant). This distribution has a low scoring values that is similar to that in FIG. 1, but it lacks the rare, high scoring values that correspond to accurate identifications. The distribution was derived from the top 4096 results (mean=21.3, sd=5.4).

FIGS. 4 and 5 are plots of the high probability tails of FIGS. 1 and 2, respectively, after transformation and linear regression.

The comparison of scoring in Table 1 gives the ENR values estimated from FIGS. 4 and 5; and the corresponding Z_{ProFound} calculated for the top ten results in the results sets given in FIGS. 1 and 2. The top three results of the yeast protein are true matches (similar sequences) as demonstrated by the low ENR values. All the other results are random matches. None of the results of the green plant protein are true matches, shown by the relatively large ENR values. Table 1 shows that estimated ENR values are as good as Z_{ProFound} values for determining which results are true identifications.

TABLE 1

| | | Z_{profound} | | Z_{profound} |
|---|---|---|---|---|
| Result rank | ENR (yeast) | (yeast) | ENR (plants) | (plants) |
| 1 | 3.6 × 10⁻⁵ | 2.4 | 1.4 | 0.69 |
| 2 | 7.4 × 10⁻⁵ | 2.1 | 1.9 | 0.28 |
| 3 | 0.041 | 0.67 | 1.9 | 0.20 |
| 4 | 0.78 | — | 2.6 | — |
| 5 | 0.78 | — | 2.6 | — |
| 6 | 1.0 | — | 3.7 | — |
| 7 | 2.4 | — | 3.7 | — |
| 8 | 2.8 | — | 3.7 | — |
| 9 | 2.8 | — | 3.7 | — |
| 10 | 3.2 | — | 4.3 | — |

We claim:

1. A method for determining the probability that a biological molecule identification is random for a chosen significance level and for a particular experimental condition, the method comprising:
(a) providing biological molecule identification search result scores for an unknown biological molecule;
(b) determining the frequency of each score to provide a frequency distribution of the scores;
(c) determining the score associated with the mean of the distribution;
(d) selecting parameters, defined as p₁ and p₂, wherein p₁ is a score within a 10% range of the score associated with the mean, and p₂ is a score which is greater than p₁ and which has a frequency 1-15% of the frequency of p₁;
(e) fitting the distribution into a curve between points p₁ and p₂;
(f) choosing a test score;
(g) extrapolating the curve to obtain an expected frequency of the test score; and
(h) assessing the expected frequency of the test score to determine the probability that the biological molecule identification is random for the chosen significance level.

2. The method according to claim 1 further comprising transforming the distribution so that the distribution is amenable to curve fitting.

3. The method according to claim 2 wherein the distribution is transformed to be amenable to fitting a straight line.

4. The method according to claim 3 wherein the distribution is transformed by taking the logarithm of the scores and the frequency values.

5. The method according to claim 1 wherein p₁ is the mean of the distribution.

6. The method according to claim 1 wherein p₂ has a frequency 10% of the frequency of p₁.

7. The method according to claim 1 wherein the unknown biological molecule is in a mixture of biological molecules.

8. The method according to claim 1 wherein the biological molecule identification search result scores are generated from the comparison of mass data of an unknown biological molecule with mass data from a biological molecule database.

9. The method according to claim 8 wherein the mass data from the biological molecule database are generated by a computer.

10. The method according to claim 6 wherein the mass data from the biological molecule database are generated by a mass spectrometer.

11. The method of claim 1 wherein the biological molecules are proteins.

12. The method of claim 1 wherein the biological molecules are nucleic acid molecules.

13. The method of claim 1 wherein the biological molecules are polysaccharides.

14. The method according to claim 8 wherein the experimental condition comprises generation of the mass data by chemical degradation of the biological molecules.

15. The method according to claim 14 wherein the experimental condition further defines an efficiency of the chemical degradation.

16. The method of claim 14 wherein the chemical degradation is by trypsin.

17. The method according to claim 8 wherein the comparison is constrained to database biological molecules within a chosen mass range.

18. The method according to claim 17 wherein the chosen mass range is within 25% of the mass of the unknown biological molecule.

19. The method according to claim 17 wherein the chosen mass range within is from about 0.1 to about 3000 kDa.

20. The method according to claim 8 wherein the comparison is constrained to database biological molecules within a chosen isoelectric point range.

21. The method according to claim 20 wherein the isoelectric point range is within 25% of the isoelectric point of the unknown biological molecule.

22. The method according to claim 8 wherein the experimental condition defines a particular accuracy for mass data determination.

23. The method according to claim 8 wherein the comparison comprises known biological molecules which exhibit modifications.

24. The method according to claim 23 wherein the modifications of the biological molecules are post translational modifications of proteins.

25. The method according to claim 8 wherein fragment mass data is generated for at least one constituent part of the biological molecules.

26. The method according to claim 25 wherein the comparison between data for the known biological molecules comprises the comparison of the fragment mass data.

27. The method according to claim 26 wherein the experimental condition defines the energy used to generate the fragment mass data.

28. The method according to claim 26 wherein the energy used to generate the fragment mass data is vibrational or electronic excitation.

29. The method according to claim 28 wherein the excitation is generated by collisions with electrons, photons, gas molecules or a surface.

30. A computer usable medium for determining a probability that a biological molecule identification is random for a chosen significance level and for a particular experimental condition, the computer usable medium comprising:
(a) a means for providing biological molecule identification search result scores for an unknown biological molecule;
(b) a means for determining the frequency of each score to provide a frequency distribution of the scores;
(c) a means for determining the score associated with the mean of the distribution;
(d) a means for selecting parameters, defined by p₁ and p₂; wherein p₁ is a score within a 10% range of the score associated with the mean, and p₂ is a score which is greater than p₁ and which has a frequency 1%-15% of the frequency of p₁;
(e) a means for fitting the distribution into a curve;
(f) a means for choosing a test score;
(g) a means for extrapolating the curve to obtain an expected frequency of the test score; and
(h) a means for assessing the expected frequency of the test score to determine the probability that the biological molecule identification is random for the chosen significance level.

31. A computer program product comprising:
a computer usable medium having computer readable program code means embodied in said medium for determining a probability that a biological identification is random for a chosen significance level and for a particular experimental condition, said computer program product including:
computer readable program code means for causing a computer to generate biological molecules identification search result scores for an unknown biological molecule;
computer readable program code means for causing the computer to determine the frequency of each score to provide a frequency distribution of scores;
computer readable program code means for causing the computer to determine the score associated with the mean of the distribution;
computer readable program code means for causing the computer to select parameters, defined as p₁ and p_{2;} wherein p₁ is a score within a 10% range of the score associated with the mean, and p₂ is a score which is greater than p₁ and which has a frequency 1%-15% of the frequency of p₁;
computer readable program code means for causing the computer to fit the distribution into a curve between points p₁ and p₂;
computer readable program code means for causing the computer to choose a test score;
computer readable program code means for causing the computer to extrapolate the curve to obtain an expected frequency of the test score; and
computer readable program code means for causing the computer to assess the expected frequency of the test score to determine the probability that the biological molecule identification is random for the chosen significance level.
